(19) United States
(12) Patent Application Publication
(10) Pub. No.: US 2026/0225320 A1
(43) Pub. Date: Aug. 6, 2026

(54) METHOD FOR CREATING 3D DATA FOR 3D PRINTER, METHOD FOR CREATING SHAPED ARTICLE, 3D DATA FOR 3D PRINTER, AND SHAPED ARTICLE

(71) Applicant: EPOCH COMPANY, LTD., Tokyo (JP)

(72) Inventor: Koichi NISHINO, Tokyo (JP)

(73) Assignee: EPOCH COMPANY, LTD., Tokyo (JP)

(21) Appl. No.: 19/461,325

(22) Filed: Jan. 27, 2026

(30) Foreign Application Priority Data
Jan. 31, 2025 (JP) 2025-014761

(51) Int. Cl. B29C 64/393; B29C 45/16; B33Y 10/00; B33Y 50/02

(52) U.S. Cl. CPC B29C 64/393; B29C 45/1634; B33Y 10/00; B33Y 50/02

(57) ABSTRACT

A method for creating 3D data for a 3D printer executed by a computer is provided. The method includes preparing 3D shape data of a molded article to be molded by injection molding or extrusion molding; executing, with respect to the prepared 3D shape data, flow analysis for obtaining a flow direction from an injection portion of a molten resin toward a flow front during molding in a mold for molding the molded article; attaching a texture of a marble pattern to the 3D shape data such that an extension direction of the marble pattern is located along the flow direction obtained by the flow analysis; and creating 3D data of the 3D shape data in which the a texture of a marble pattern is attached.

This application is based on and claims priority under 35 USC 119 from Japanese Patent Application No. 2025-014761 filed on Jan. 31, 20245, the contents of which are incorporated herein by reference.

### TECHNICAL FIELD

The present disclosure relates to a method for creating 3D data for a 3D printer, a method for creating a shaped article, 3D data for a 3D printer, a non-transitory computer-readable medium storing 3D data, and a shaped article.

### BACKGROUND ART

In the related art, a product has been proposed in which a marble pattern is decorated on a shaped article. For example, in the case of a resin article, a marble pattern shaped article is produced by a method such as injection molding by two-color molding in which a plurality of resins having different melting points or glass transition temperatures and colors are mixed (for example, Patent Literature 1).

### CITATION LIST

### Patent Literature

Patent Literature 1: JP2009-137192A

### SUMMARY OF INVENTION

When mass production is performed, such a resin product is produced by molding such as injection molding with a mold prepared in order to reduce the production cost. However, since the cost of producing the mold is generally high, it is not easy in practice to prepare the mold at the prototype stage of the shaped article. In order to reduce the cost, it is desirable to design and create the mold after determining the specifications of the shaped article. On the other hand, in the case of a shaped article having a marble pattern, since a complicated color or pattern is expressed as a result of resin flow in a mold, it is difficult to reproduce and evaluate an aspect close to mass production without using a mold.

Water transfer printing is a method for decorating a marble pattern on a shaped article in a prototype stage. Water transfer printing is a technique of floating a film having a pattern on a water surface, sinking a shaped article, and transferring the pattern to a surface of the shaped article. However, the water transfer printing has one or a plurality of problems such as (1) a jig corresponding to a transfer object is required because each step is manually performed, (2) it is not easy to fit a film to a complicated uneven shape, (3) it is difficult to perform processing for decorating (simultaneously) both surfaces of a transfer object having a deep cylindrical or box shape, (4) it is not possible to produce a plurality of patterns at the same time, (5) a marble pattern extends in a depth direction in which the transfer object sinks with respect to a water surface, and (6) a high level of technology is required during work and the reproducibility is not high.

Another method for decorating a marble pattern on a shaped article is in-mold molding. The in-mold molding is a molding technique in which a pre-patterned film is placed in a mold, and an outer surface of a molten resin supplied into the mold and the film are integrated to transfer a desired pattern to an outer surface of a molded article. However, the shape that can be handled by the in-mold molding is limited. In order to change the shape of the molded article, it is necessary to newly produce a mold, which is not suitable for producing a prototype with reduced cost.

Since the marble pattern has a complicated pattern, it is not easy to reproduce the marble pattern by painting.

The present disclosure has been made to solve one or a plurality of problems described above, and an object of the present disclosure is to provide a method for creating 3D data for a 3D printer, a method for creating a shaped article, 3D data for a 3D printer, and a shaped article capable of easily reproducing a shaped article having a marble pattern to be created by resin molding.

A method for creating 3D data for a 3D printer according to the present disclosure is executed by a computer. The method includes preparing 3D shape data of a molded article to be molded by injection molding or extrusion molding; executing, with respect to the prepared 3D shape data, flow analysis for obtaining a flow direction from an injection portion of a molten resin toward a flow front during molding in a mold for molding the molded article; attaching a texture of a marble pattern to the 3D shape data such that an extension direction of the marble pattern is located along the flow direction obtained by the flow analysis; and creating 3D data of the 3D shape data in which the a texture of a marble pattern is attached.

A method for creating a shaped article according to the present disclosure includes obtaining 3D data by the method for creating 3D data according to claim 1; and creating a shaped article by the 3D printer using the 3D data to which the texture is attached.

A non-transitory computer-readable medium according to the present disclosure stores 3D data for a 3D printer to be processed by a computer. The 3D data includes 3D shape data of a molded article to be molded by injection molding or extrusion molding; and a texture of a marble pattern attached to the 3D shape data such that an extension direction of the marble pattern is located along a flow direction from an injection portion of a molten resin toward a flow front during molding in a mold for molding the molded article.

A shaped article according to the present disclosure is created by the 3D printer using the above 3D data.

According to the present disclosure, it is possible to provide a method for creating 3D data for a 3D printer, a method for creating a shaped article, 3D data for a 3D printer, and a shaped article capable of easily reproducing a shaped article having a marble pattern to be created by resin molding.

### BRIEF DESCRIPTION OF DRAWINGS

FIG. 1 is an overall configuration diagram of a shaped article creation system;

FIG. 2 is a flowchart of creation of a shaped article;

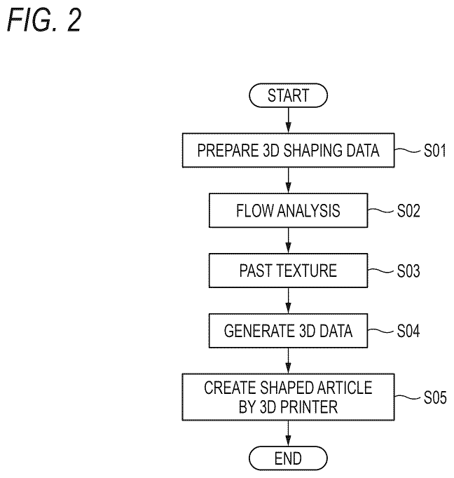

FIG. 3 is a perspective view of 3D shape data;

FIG. 4 shows a result of flow analysis;

FIG. 5 is a diagram showing creation of 3D data to which a texture is attached; and

FIG. 6 is a perspective view of the 3D data to which the texture is attached.

### DESCRIPTION OF EMBODIMENTS

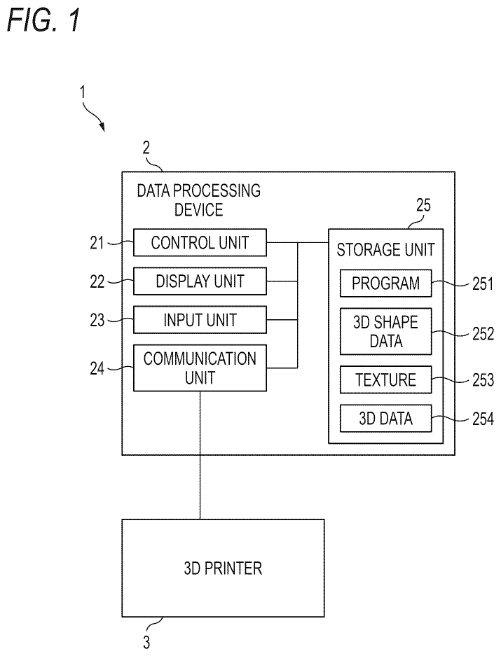

First, an embodiment of the present disclosure will be described with reference to the drawings. FIG. 1 is an overall configuration diagram of a shaped article creation system 1. The shaped article creation system 1 has a function of creating a shaped article (a prototype) imitating a molded article of a marble pattern (a marble-like pattern) molded by injection molding, extrusion molding, or the like. The shaped article creation system 1 includes a data processing device 2 and a 3D printer 3.

The data processing device 2 is, for example, a personal computer, and may be another device such as a tablet terminal, a server, a portable information terminal, or a wearable device. The data processing device 2 includes a control unit 21, a display unit 22, an input unit 23, a communication unit 24, and a storage unit 25.

The control unit 21 executes a function and/or a method that is implemented by a code or an instruction in a program 251 stored in the storage unit 25. As the control unit 21, for example, a central processing unit (CPU), a micro-processing unit (MPU), a GPU, a microcontroller unit (MCU), a processor core, a multiprocessor, an ASIC, an FPGA, or the like can be applied, and the processing disclosed in the embodiments may be implemented by a logic circuit or a dedicated circuit formed in an integrated circuit or the like. These circuits may be implemented by one or a plurality of integrated circuits, or a plurality of pieces of processing described in the embodiments may be implemented by one integrated circuit.

The display unit 22 is, for example, a liquid crystal, an organic light emitting diode (OLED), or a wearable display device.

The input unit 23 is an interface for inputting information or an instruction to the data processing device 2. The input unit 23 includes a part or a plurality of a sound input unit such as a microphone, a light receiving unit such as an imaging unit, a physical input unit such as a keyboard, a mouse, a slide switch, or a push button switch, or a touch panel integrally formed with the display unit 22.

The communication unit 24 has a wired or wireless information communication function with an external device such as the 3D printer 3. The communication unit 24 may include an interface for connecting to an external storage medium.

The storage unit 25 stores the program 251 for controlling the data processing device 2 and various types of data (252, 253, 254) for creating a shaped article. The program 251 may include a program such as 3D modeling software (for example, computer-aided design (CAD) for creating or editing three-dimensional graphic data on the data processing device 2 (a computer), an image editing application for creating or editing data of the texture 253, or other programs. As the storage unit 25, a storage medium such as a hard disk drive (HDD), a solid state drive (SSD), or a flash memory can be used.

The 3D shape data 252 is shape data of a molded article to be molded by resin molding such as injection molding or extrusion molding. The 3D shape data 252 is used as, for example, data for producing a mass-produced product (a product), reference data for designing a mold, and original data of the 3D data 254 for creating a shaped article in the 3D printer 3. The 3D shape data 252 is created by the data processing device 2 using 3D modeling software, for example.

The texture 253 is pattern data to which a marble pattern is applied and which is attached to the 3D shape data 252. The marble pattern is not limited to a pattern imitating marble, and includes a pattern imitating wood grain, granite, a jade, a cloud shape, or the like. The marble pattern can include, for example, one or a plurality of a flow pattern, a natural layered pattern (for example, a geological layer or an annual ring), an irregular pattern that is not symmetrical, a color change in which one color gradually blends into another color, a spiral undulation pattern, and a gradation pattern including light and dark shades.

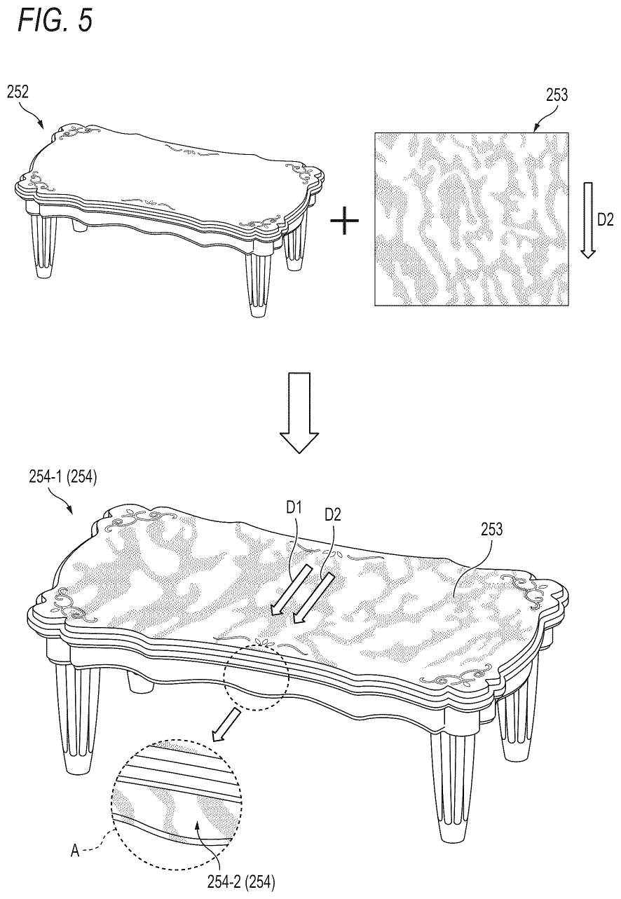

Since the marble pattern according to the present embodiment further reproduces a pattern expressed by resin molding by the 3D printer 3, the marble pattern has an extension direction D2 (see FIG. 5) extended in one direction in order to express “extension” due to flow during molding. The “extension” is, for example, an elliptical pattern formed by stretching a circular pattern, a linear pattern, or a curved pattern formed by stretching a part of a linear pattern in one direction and forming a convex shape or a concave shape.

The 3D data 254 is data created by attaching the texture 253 to the 3D shape data 252.

The 3D printer 3 can use any method such as a fused deposition modeling method, a stereolithography method, or a powder bed fusion method. The 3D printer 3 according to the present embodiment is a full-color 3D printer.

Next, a method for creating a shaped article using the shaped article creation system 1 will be described. A process of step S01 to step S04 is an example of a method for creating 3D data for the 3D printer 3 executed by the data processing device 2 (the computer). The process includes a process of creating 3D data by the method for creating 3D data from step S01 to step S04, and a process of step S05. The process of step S05 is an example of the method for creating a shaped article by the 3D printer 3 using the 3D data 254, and is executed by the 3D printer 3 (the computer).

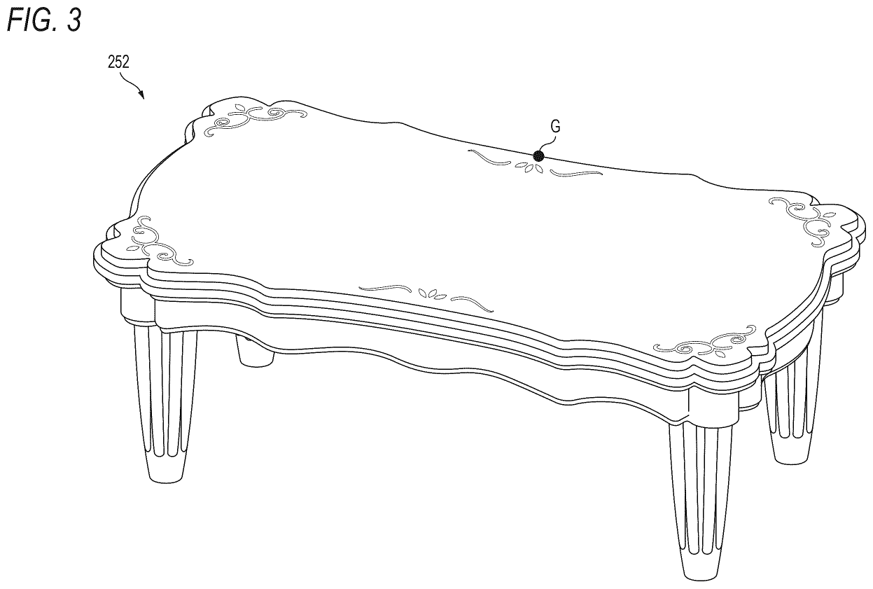

First, in step S01, the data processing device 2 executes 3D modeling software, which is one of the programs 251, to create any 3D shape data 252. In the present embodiment, for example, the 3D shape data 252 of a table for a toy imitating a dining table as shown in FIG. 3 is created.

In step S02, the data processing device 2 sets the position of a gate G (a resin injection portion) in the mold for the 3D shape data 252 according to an instruction input by a user (see FIG. 3). In the example in FIG. 3, the 3D shape data 252 has a substantially symmetrical shape in the front-rear and left-right directions. The gate G is provided at one position on one side in the front-rear direction and the upper portion (one end portion in the short direction and the substantially center in the long direction of the top plate of the desk) in the substantially center in the left-right direction.

The gate G may be set at two or more positions.

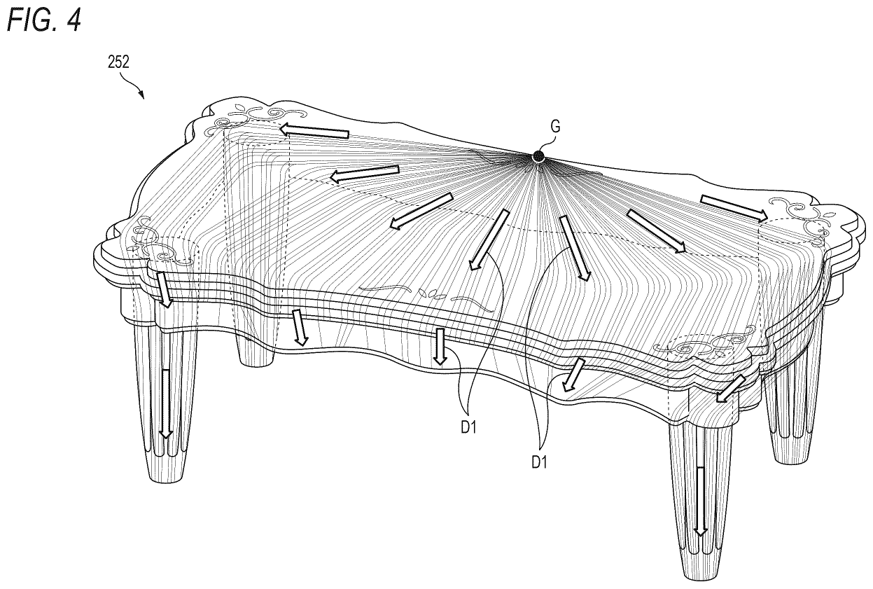

The data processing device 2 uses the 3D shape data 252 of a molded article to be molded by injection molding or extrusion molding to execute flow analysis for obtaining a flow direction D1 from the gate G (the injection portion) of a molten resin toward a flow front during molding in a mold for molding the molded article (see FIG. 4). In the present embodiment, a program for flow analysis in the 3D modeling software is used.

As a result of the flow analysis, the data processing device 2 obtains the flow direction D1 of the resin of the created 3D shape data 252 with reference to the simulation moving image and the flow diagram.

In step S03, the data processing device 2 attaches the texture 253 of the marble pattern to the 3D shape data so as to set the extension direction D2 of the marble pattern along the flow direction D1 obtained by the flow analysis according to the instruction input by a user or automatically. FIG. 5 shows 3D data 254-1 (254) in a state in which the texture 253 is attached to the top surface of the top plate of the 3D shape data 252. The texture 253 is attached in a different direction as necessary with reference to the flow direction D1 of the parts on the top plate.

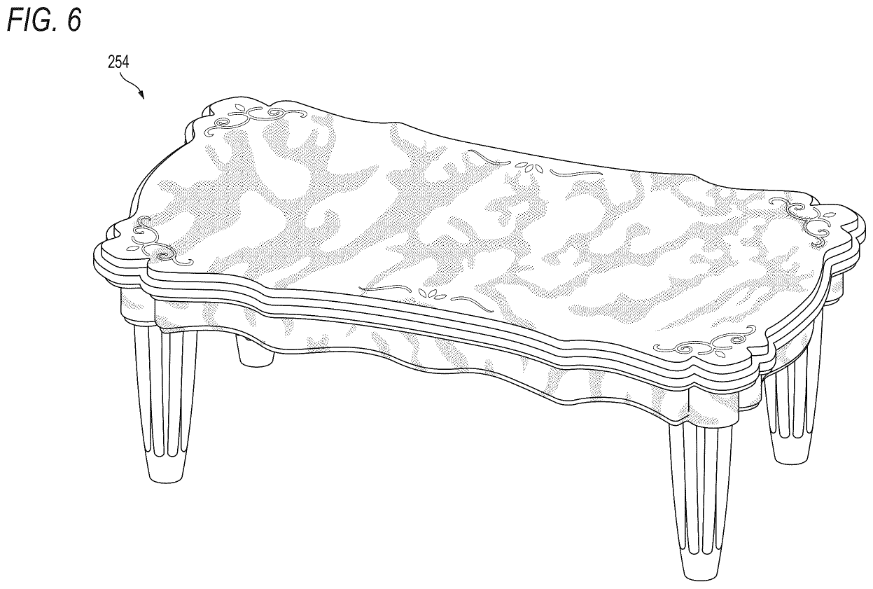

For the 3D data 254-1 in a state in which the texture 253 is attached to the top surface of the top plate, the texture 253 is further attached to the side surface of the top plate as shown in an enlarged view of a part A (3D data 254-2). FIG. 6 shows that texture 253 is attached to both the top surface of the top plate and the side surface of the top plate.

In step S04, when completing the pasting of the texture 253 to the 3D shape data 252, the data processing device 2 generates the 3D data 254 for the 3D printer 3. The 3D data 254 is, for example, in a stereolithography (STL) format. The generated 3D data 254 is stored in the storage unit 25.

The data processing device 2 may create the 3D data 254 of different designs using different types of textures 253 and store a plurality of pieces of 3D data in the storage unit 25.

In step S05, the data processing device 2 transmits the 3D data 254 (see FIG. 6) via wired or wireless communication or via the storage medium of the user. The 3D printer 3 (the computer) creates (outputs) a shaped article using the 3D data 254 to which the texture 253 is attached. When a plurality of pieces of 3D data 254 are stored in the storage unit 25, the 3D printer 3 may create (for example, continuously) a plurality of shaped articles based on different 3D data 254.

The present embodiment has been described above. In the method for creating a prototype using water transfer printing in the related art, after creating 3D shape data, processes of cutting or 3D printer shaping, surface finishing, creation of a film with a pattern, water transfer printing, and clear coat painting are performed. However, after creating 3D shape data, by creating a shaped article by processes of flow analysis (analog or digital analysis), pasting of a marble pattern texture using the 3D modeling software, and shaping with the 3D printer 3, labor and time can be significantly reduced.

The analog flow analysis described above is, for example, a method of obtaining (or analyzing) the flow direction D1 based on a state of an injection molded article having a similar shape created in the past. The analog flow analysis can be applied when there is a track record of creating a marble pattern or other molded articles in which the flow state can be visualized by resin molding in the past or when the shape is simple. The obtained flow direction D1 may be input to the 3D modeling software or stored in association with the 3D shape data 252.

In the method for creating a shaped article according to the present embodiment, a high-level skill such as water transfer printing is unnecessary, and the shaped article can be created with high reproducibility.

Even if the shaped article produced by the method according to the present embodiment has a shape with complicated unevenness or an edge portion, the pattern can be reproduced even in this part. Unlike the water transfer printing, the pattern can be reproduced neatly and without discomfort not only on the front side (the convex side) of the shaped article but also on the back side (the concave side).

The flow analysis of the resin in the mold is usually used to estimate the pressure distribution of the resin, the temperature distribution of the resin, the position where the weld line occurs, and other molding defects. However, in the present embodiment, the flow analysis is used for a purpose different from the normal purpose, that is, the flow analysis is used to estimate the manner in which the pattern is applied in the molded article to create a shaped article in a prototype stage before the mold is created. Accordingly, it is possible to create a shaped article having a marble pattern close to an injection molded article.

Since the plurality of pieces of 3D data 254 having different patterns can be created and the 3D printer 3 can simultaneously (for example, continuously) create the shaped article, it is possible to significantly reduce the time until the design is evaluated. For example, by creating the plurality of pieces of 3D data 254 of shaped articles having textures of different patterns or colors, shaped articles having different patterns can be evaluated in a short period of time. Accordingly, a molded article of the pattern having a design intended by a designer can be quickly created with high reproducibility while simulating creation using a mold such as injection molding or extrusion molding.

Since the shaped article created by the creation method according to the present embodiment is created by the 3D printer 3, the shaped article is resistant to rubbing or the like and has excellent durability as compared with water transfer printing.

In the case of injection molding, an individual difference occurs in the manner in which the marble pattern is applied. However, in the case of shaping using the 3D printer 3, the same pattern can be reproduced, and thus the shaping is suitable for evaluation. At the time of conditioning in a molding process using a mold, a sample (a non-defective product sample, a limit sample, or the like) of a target pattern may be used.

When the 3D printer 3 is used, a marble pattern having an appearance can also be expressed in which resin flow such as molding is ignored. For example, as a component to be combined and coupled to a molded article such as injection molding or extrusion molding, a shaped article having a pattern with a tendency different from the flow direction of the resin by the mold may be formed and used by the 3D printer 3. Accordingly, it is also possible to form a shaped article having various variations of patterns that are difficult to achieve only by resin molding. Such a combined shaped article may be applied as a mass-produced article.

By using the 3D printer 3, it is possible to design and create variations of various types and small lots at a time, and it is also possible to meet various needs of users who purchase products.

According to the embodiment of the present disclosure as described above, it is possible to provide a method for creating 3D data for a 3D printer, a method for creating a shaped article, 3D data for a 3D printer, and a shaped article according to the following aspects.

A method for creating 3D data for a 3D printer according to a first aspect is a method for creating 3D data for a 3D printer executed by a computer, the method including: causing the computer to execute a process of using 3D shape data of a molded article to be molded by injection molding or extrusion molding to execute flow analysis for obtaining a flow direction from an injection portion of a molten resin toward a flow front during molding in a mold for molding the molded article; and a process of attaching a texture of a marble pattern to the 3D shape data such that an extension direction of the marble pattern is along the flow direction obtained by the flow analysis.

According to this aspect, it is possible to create 3D data for creating a shaped article of a marble pattern imitating shaping by resin molding by flow analysis without creating a mold for resin molding. Since the 3D data can be used as shaping data of any 3D printer, a shaped article of a marble pattern to be created by resin molding can be easily reproduced without using a mold.

A method for creating a shaped article according to a second aspect, the method including: a process of creating 3D data by the method for creating 3D data according to the first aspect; and a process of creating a shaped article by the 3D printer using the 3D data to which the texture is attached.

According to this aspect, it is possible to easily create and reproduce a shaped article of a marble pattern to be created by resin molding without using a mold.

3D data for a 3D printer according to a third aspect is 3D data to be processed by a computer, the 3D data including: 3D shape data of a molded article to be molded by injection molding or extrusion molding; and a texture of a marble pattern attached to the 3D shape data such that an extension direction of the marble pattern is along a flow direction from an injection portion of a molten resin toward a flow front during molding in a mold for molding the molded article.

According to this aspect, the 3D data has an aspect close to a shaped article of a marble pattern imitating shaping by resin molding by flow analysis without creating a mold for resin molding. Therefore, it is possible to easily reproduce a shaped article of a marble pattern to be created by resin molding without using a mold. This 3D data can be used as shaping data of any 3D printer.

A shaped article according to a fourth aspect is a shaped article to be created by the 3D printer using the 3D data according to the third aspect.

According to this aspect, it is possible to easily reproduce a shaped article of a marble pattern to be created by resin molding without using a mold.

The embodiment of the present disclosure has been described above. The aspects of the present disclosure are not limited to this embodiment. For example, in the present embodiment, a configuration has been described in which the data processing device 2 and the 3D printer 3 are separate devices. Alternatively, the data processing device 2 and the 3D printer 3 may be an integrated device including the data processing device 2 and the 3D printer 3.

A part of functions (for example, the display unit 22, the input unit 23, the communication unit 24, and the storage unit 25) of the data processing device 2 may be provided as an external device connected to the data processing device 2. For example, in addition to being provided in the data processing device 2, the storage unit 25 may be implemented as an external storage unit (for example, a cloud server) and store a part or a plurality of the program 251, the 3D shape data 252, the texture 253, and the 3D data 254 that operate in the shaped article creation system 1 (the data processing system) according to the present embodiment.

In the present embodiment, an example has been described in which the 3D shape data 252 is created by the data processing device 2. Alternatively, the 3D shape data 252 may be data acquired from the outside of the data processing device 2. That is, the process of creating the 3D shape data 252 in step S01 can be omitted.

What is claimed is:

1. A method for creating 3D data for a 3D printer executed by a computer, the method comprising:
preparing 3D shape data of a molded article to be molded by injection molding or extrusion molding;
executing, with respect to the prepared 3D shape data, flow analysis for obtaining a flow direction from an injection portion of a molten resin toward a flow front during molding in a mold for molding the molded article;
attaching a texture of a marble pattern to the 3D shape data such that an extension direction of the marble pattern is located along the flow direction obtained by the flow analysis; and
creating 3D data of the 3D shape data in which the a texture of a marble pattern is attached.

2. A method for creating a shaped article, the method comprising:
creating 3D data by the method for creating 3D data according to claim 1; and
creating a shaped article by the 3D printer using the 3D data to which the texture is attached.

3. A non-transitory computer-readable medium storing 3D data for a 3D printer to be processed by a computer, the 3D data comprising:
3D shape data of a molded article to be molded by injection molding or extrusion molding; and
a texture of a marble pattern attached to the 3D shape data such that an extension direction of the marble pattern is located along a flow direction from an injection portion of a molten resin toward a flow front during molding in a mold for molding the molded article.

4. A shaped article to be created by the 3D printer using the 3D data according to claim 3.
